(19) United States
(12) Patent Application Publication
(10) Pub. No.: US 2019/0084429 A1
(43) Pub. Date: Mar. 21, 2019

(54) ELECTRIC MACHINE DIAGNOSTIC INFORMATION

(71) Applicant: Ford Global Technologies, LLC, Dearborn, MI (US)

(72) Inventors: Jiyao Wang, Canton, MI (US); Wei Xu, Canton, MI (US)

(21) Appl. No.: 15/710,501

(22) Filed: Sep. 20, 2017

(51) Int. Cl. B60L 9/22; H02P 21/18; G06F 17/11

(52) U.S. Cl. CPC B60L 9/22; B60L 2220/10; G06F 17/11; H02P 21/18

(57) ABSTRACT

A vehicle includes a pair of inverters coupled with an electric machine having a rotor. The vehicle includes a controller configured to alter pulse width modulation signals for the commands based on a back electromotive force estimate associated with the commands becoming different to reduce the amount. The alteration is responsive to voltage commands of respective phases of the pair becoming different while a target rotor speed associated with the commands differs from an actual rotor speed by an amount.

### TECHNICAL FIELD

This disclosure relates to electric machine diagnostic information.

### BACKGROUND

Inverters are used to operate electric machines. Some electric machines may be operated by more than one inverter to reduce inefficiencies associated with high-output, lone inverters. Because of physical placement of the inverters within vehicles or other factors, the wear and use of each inverter may be unequal.

### SUMMARY

A vehicle includes a pair of inverters coupled with an electric machine including a rotor. The vehicle includes a controller configured to alter pulse width modulation signals for the commands based on a back electromotive force estimate associated with the commands becoming different to reduce the amount. The alteration is responsive to voltage commands of respective phases of the pair becoming different while a target rotor speed associated with the commands differs from an actual rotor speed by an amount.

A method by a controller includes altering pulse width modulation signals for the commands based on a back electromotive force estimate associated with commands becoming different to reduce the amount. The altering is responsive to voltage commands of respective phases of a pair of inverters coupled with an electric machine becoming different while a target rotor speed associated with the commands differs from an actual rotor speed by an amount.

A vehicle includes a pair of inverters coupled with an electric machine including a rotor. The vehicle includes a controller configured to alter commands of respective phases of the pair to introduce a difference therebetween. The alteration is responsive to a target rotor speed associated with voltage commands of the pair differing from an actual rotor speed by an amount. The controller is configured to alter pulse width modulation signals for the commands based on a back electromotive force estimate associated with the commands becoming different to reduce the amount. The alteration is responsive to the difference.

### BRIEF DESCRIPTION OF THE DRAWINGS

FIG. 1 is a schematic overview of a vehicle;

FIG. 2 is a functional diagram of an electrical drive system controller; and

FIG. 3 is an algorithm for updating a mathematical model of a pair of inverters;

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric machines may be associated with more than one inverter for operation. The inverters may be wired to operate the electric machine using multiple leads organized on the same or similar phases. As an example, an electric machine may have six leads—three from each inverter—and operate on three phases. A power demand may be provided by a user or an autonomous source and sent to the gate driver of the inverter to operate the inverters. According to this disclosure, the inverters may be differentially operated such that different portions of the total operating power of the electric machine are supplied or received by each of the inverters to supply the demand.

The controller may determine which inverter to use by assessing a variety of operational factors. For example, the controller may look at a temperature difference between the inverters. The temperature difference may be ambient as well. Inverters in higher temperatures may have reduced efficiency and longevity. The controller may be configured to alter the disparity of each inverters' power output based on the temperature difference. The controller may be configured to shutdown the one of the two inverters when the temperature of one of the inverters exceeds a predetermined threshold. The controller may operate the other of the two inverters to provide power to meet demand.

The controller may also purposefully alter the power output of the inverters to update a mathematical model of the electric machine. A mathematical model may be used to determine rotor position and speed without the use of sensors or to reduce the number of sensors used. For example, a mathematical model of a permanent magnet synchronous machine may be formed from either a stationary or rotating reference frame. In a rotating reference frame, direct and quadrature axes are used (i.e., d-q). A set of equations may be used to define the mathematical model of the electric machine rotor position and speed, as shown in Equation 1.

$$[ \begin{matrix}\sum {v}_{q} \\ \sum {v}_{d} \\ Δ {v}_{q} \\ Δ {v}_{d}\end{matrix} ] = ( {L}_{leak} [ \begin{matrix}1 & & & \\ & 1 & & \\ & & 1 & \\ & & & 1\end{matrix} ] + [ \begin{matrix}{L}_{q} & & & \\ & {L}_{d} & & \\ & & & \\ & & & \end{matrix} ] ) \frac{d}{dt} [ \begin{matrix}\sum {i}_{q} \\ \sum {i}_{d} \\ Δ {v}_{q} \\ Δ {v}_{d}\end{matrix} ] + {ω}_{ɛ} ( {L}_{leak} [ \begin{matrix} & 1 & & \\ - 1 & & & \\ & & & 1 \\ & & - 1 & \end{matrix} ] + [ \begin{matrix} & {L}_{d} & & \\ - {L}_{q} & & & \\ & & & \\ & & & \end{matrix} ] ) [ \begin{matrix}\sum {i}_{q} \\ \sum {i}_{d} \\ Δ {v}_{q} \\ Δ {v}_{d}\end{matrix} ] + {R}_{s} [ \begin{matrix}1 & & & \\ & 1 & & \\ & & 1 & \\ & & & 1\end{matrix} ] [ \begin{matrix}\sum {i}_{q} \\ \sum {i}_{d} \\ Δ {v}_{q} \\ Δ {v}_{d}\end{matrix} ] + {ω}_{ɛ} {λ}_{pm} [ \begin{matrix}1 \\ 0 \\ 0 \\ 0\end{matrix} ] , \qquad ( 1 )$$

where each term corresponds to an inductance term, cross-coupling term, resistance term, and back-electromagnetic force (EMF) term, respectively. The back-EMF term,

$${ω}_{ɛ} {λ}_{pm} [ \begin{matrix}1 \\ 0 \\ 0 \\ 0\end{matrix} ] ,$$

may be calculated using Equation 1 when

$$[ \begin{matrix}\sum {v}_{q} \\ \sum {v}_{d} \\ Δ {v}_{q} \\ Δ {v}_{d}\end{matrix} ]$$

is determined using linear transformations of Equation 2 below.

$$[ \begin{matrix}\sum {v}_{q} \\ \sum {v}_{d} \\ Δ {v}_{q} \\ Δ {v}_{d}\end{matrix} ] = [ \begin{matrix}\sum {v}_{q} Cmd \\ \sum {v}_{d} Cmd \\ Δ {v}_{q} Cmd \\ Δ {v}_{d} Cmd\end{matrix} ] + [ \begin{matrix}{ACdist}_{1} \\ {ACdist}_{2} \\ {ACdist}_{3} \\ {ACdist}_{4}\end{matrix} ] + [ \begin{matrix}{DCdist}_{1} \\ {DCdist}_{2} \\ 0 \\ 0\end{matrix} ]$$

where ACdist is the alternating current portion of the inverter non-linearity and DCdist is the DC portion of the inverter non-linearity. With the difference between the quadrature voltage command (Δv_{q}Cmd) and the difference between the direct voltage command (Δv_{d}Cmd) being known, ACdist_{3,4} can be ascertained. ACdist_{3,4} are co-related with ACdist_{1,2} based on the inverter deadtime. With ACdist₁₋₄ being known, DCdist_{1,2} can be ascertained. Whenever any two of the ACdist or DCdist is know, the other four disturbances may be determined. Meaning, a difference in voltage commands can provide derivation of the necessary information to determine back-EMF without requiring assumptions to be made regarding DCdist. Identical inverters may be necessary to generate accurate mathematical models or the disparity between each inverter' s performance may be determined before installation.

The controller may change the power output by adjusting a pulse width modulation signal sent to gates of the one of the two inverters. A modulation index of one of the inverters may be adjusted to alter the power output. An acceleration pedal or other user input device may provide the demand. In other embodiments, an autonomous vehicle controller may provide the input.

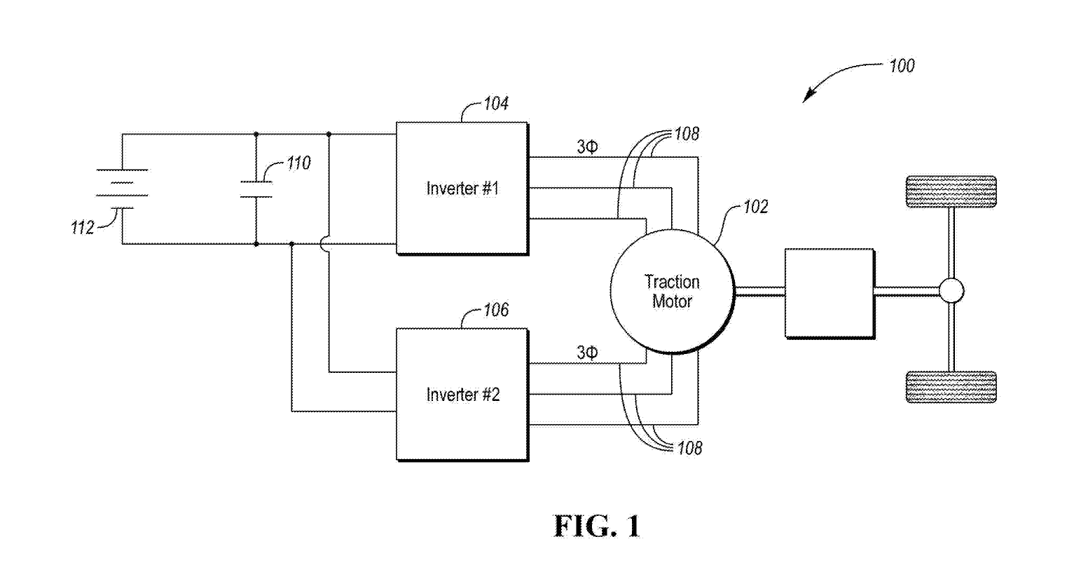

Referring to FIG. 1, a portion of a vehicle 100 is shown. The vehicle includes a traction motor or electric machine 102. More than one electric machine 102 may be used. The electric machine 102 may be connected to a drivetrain that includes a transmission and wheels. The electric machine 102 as shown is a six-lead, three-phase electric machine 102. The electric machine 102 is operated by a pair of three-phase inverters 104, 106. Each phase 108 has its own lead to operate the electric machine 102. As discussed above, any number of inverters may be used and the use of three phases is not required. The inverters 102 may be powered by the same or independent DC busses that include a direct current source 112. The DC bus may include a DC link capacitor 110.

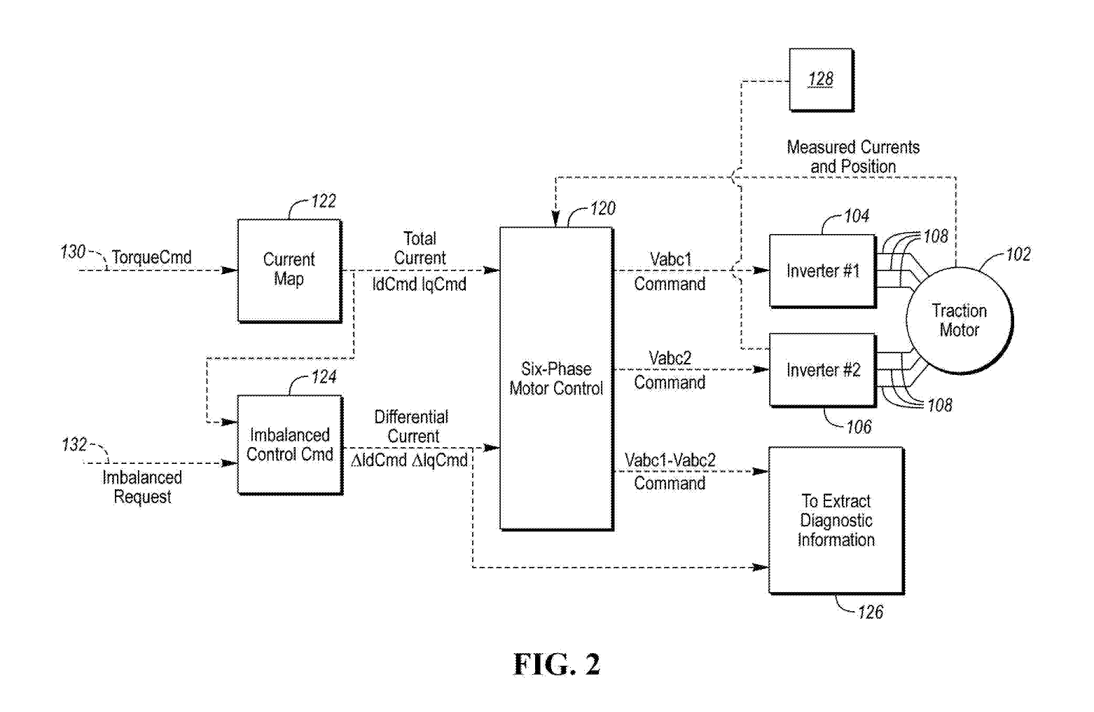

Referring to FIG. 2, a torque command 130 is provided from a torque demand or input. The torque demand or input may be from an operator or autonomous input. The torque command is fed into the current map 122 function block to determine the current demand based on pre-calibrated current maps. The electric machine 102 delivers the desired torque when its phase currents match the current command. The total current demand is sent to the six-phase motor control 120 function block and the imbalanced control command 124 function block. The imbalanced control command 124 function block also receives an imbalanced request 132, which may be from another controller that evaluates climate or use conditions for each of the inverters 104, 106. The imbalanced control command 124 function block sends a differential current command to the six-phase motor control 120 function block. The six-phase motor control 120 function block receives the current command and outputs corresponding voltage commands, in pulse width modulation (PWM) signals to achieve desired motor current for each phase. The six-phase motor control 120 function block includes closed-loop current regulation to match the actual current to the current commands, which includes the total current and differential current commands. The PWM signals are sent to gates of the inverters 104, 106 to generate corresponding three phase current 108 to the electric machine 102. The differential current command and differential PWM signals may be used to extract diagnostic information 126 from the electric machine 102.

The imbalanced control command 124 function block may receive an imbalanced request 132 based on a variety of factors. For example, the imbalanced request 132 could be based on different physical locations, an inverter mismatch, a motor winding mismatch, temperature differences. The controller 128 may be configured to switch between the inverters 104, 106 in an organized fashion to disburse the use of the inverters 104, 106. For example, the inverters may be configured to run on for 10 hours and then off for 10 hours when the current command 130 can be fulfilled by only one of the inverters 104, 106.

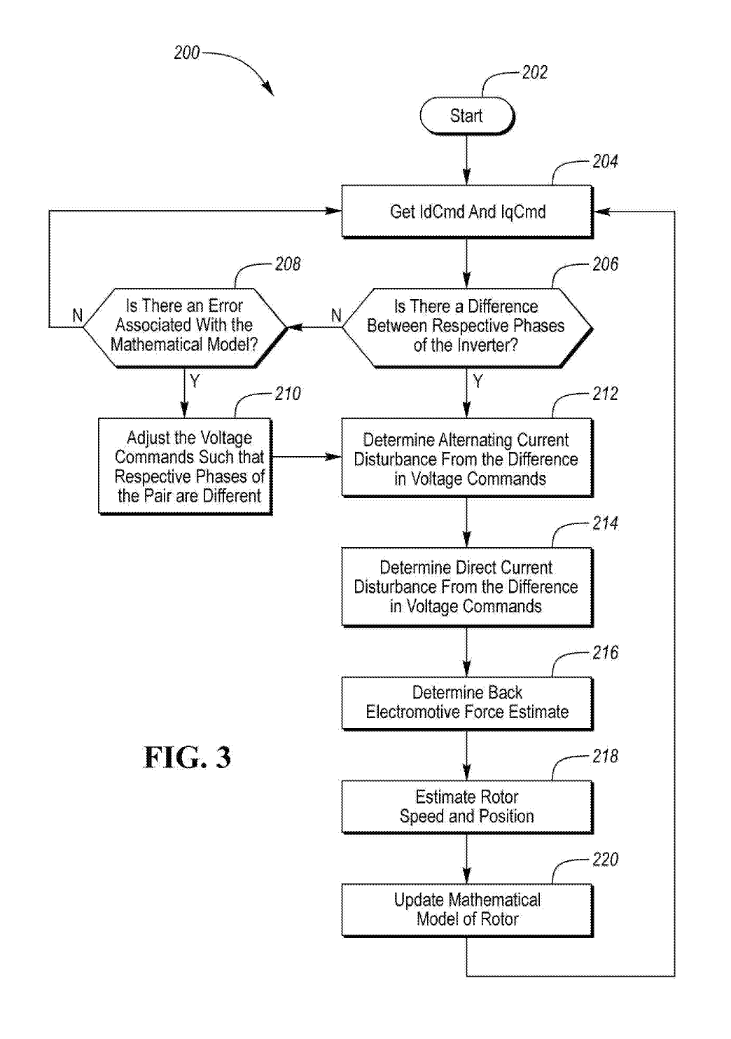

Referring to FIG. 3, an algorithm 200 is shown. The algorithm 200 may be performed in any order and may not include all the steps listed. The algorithm 200 starts in step 202. In step 204 the Id command and I_{q} command are determined. The controller may also determine the V_{d} command and V_{q} command. In step 206, the controller may determine whether there is a difference between voltage or current commands among respective phases of the inverter. For example, Phase A of Inverter 1 may have 1% smaller voltage command than Phase A of Inverter 2.

If the inverters have the same or substantially similar commands, the controller may determine whether there is an error associated with the mathematical model for the rotor in step 208. For example, the controller may observe unanticipated output or behavior related to the electric machine and determine that the behavior is related to the mathematical model of the rotor. If an error is detected, the controller may purposefully adjust the commands sent to the inverter such that respected phases of the pair are different. This difference may be minute and only intended to offset the respective phases such that the mathematical model can be updated as specified above in step 210. Although the voltage command is used in this algorithm, the voltage command may be adjusted by a change in the preceding current commands or other adjustable parameters of the controller.

If there is a difference between the respective phases of the inverter, the controller may determine

$$[ \begin{matrix}\sum {v}_{q} \\ \sum {v}_{d} \\ Δ {v}_{q} \\ Δ {v}_{d}\end{matrix} ]$$

using known quantities based on the difference. For example, the controller may determine the alternating current disturbance from the difference in voltage commands in step 212. The difference may be determined using linear transformations and Equation 2. The controller may determine direct current disturbances from a combination of the differential voltage commands and the alternating current disturbance in step 214. Through these determinations, the back-EMF estimate of Equation 1 may be updated in step 216. Meaning the electric machine mathematical model of Equation 1 may be corrected to remove error associated with the rotor speed and position estimate of step 218 to reduce an error amount associated with the mathematical model of Equation 1 in step 220.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a pair of inverters coupled with an electric machine including a rotor; and
a controller configured to, responsive to voltage commands of respective phases of the pair becoming different while a target rotor speed associated with the commands differs from an actual rotor speed by an amount, alter pulse width modulation signals for the commands based on a back electromotive force estimate associated with the commands becoming different to reduce the amount.

2. The vehicle of claim 1, wherein the pair have a same construction.

3. The vehicle of claim 1, wherein the controller is further configured to estimate an alternating current disturbance of the voltages based on the commands becoming different.

4. The vehicle of claim 3, wherein the controller is further configured to estimate a direct current disturbance of the voltages based on the commands becoming different.

5. The vehicle of claim 4, wherein the controller is further configured to determine the direct current disturbance and the alternating current disturbance using a linear transformation.

6. The vehicle of claim 1, wherein the estimate is associated with a position of the rotor.

7. A method comprising:
responsive to voltage commands of respective phases of a pair of inverters coupled with an electric machine becoming different while a target rotor speed associated with the commands differs from an actual rotor speed by an amount, by a controller altering pulse width modulation signals for the commands based on a back electromotive force estimate associated with the commands becoming different to reduce the amount.

8. The method of claim 7, wherein the pair have a same construction.

9. The method of claim 7 further comprising estimating an alternating current disturbance of the voltages based on the commands becoming different.

10. The method of claim 9 further comprising estimating a direct current disturbance of the voltages based on the commands becoming different.

11. The method of claim 10 further comprising determining the direct current disturbance and the alternating current disturbance using a linear transformation.

12. The method of claim 7, wherein the estimate is associated with a position of the rotor.

13. A vehicle comprising:
a pair of inverters coupled with an electric machine including a rotor; and
a controller configured to,
responsive to a target rotor speed associated with voltage commands of the pair differing from an actual rotor speed by an amount, alter the commands of respective phases of the pair to introduce a difference therebetween, and
responsive to the difference, alter pulse width modulation signals for the commands based on a back electromotive force estimate associated with the commands becoming different to reduce the amount.

14. The vehicle of claim 13, wherein the pair have a same construction.

15. The vehicle of claim 13, wherein the controller is further configured to estimate an alternating current disturbance of the voltages based on the difference.

16. The vehicle of claim 15, wherein the controller is further configured to estimate a direct current disturbance of the voltages based on the difference.

17. The vehicle of claim 16, wherein the controller is further configured to determine the direct current disturbance and the alternating current disturbance using a linear transformation.

18. The vehicle of claim 13, wherein the estimate is associated with a position of the rotor.
